(19) United States
(12) Patent Application Publication
(10) Pub. No.: US 2009/0157501 A1
(43) Pub. Date: Jun. 18, 2009

(54) Integrated Exchange for 24 hour real time trading of fungibles & continuous cash T+0 settlement

(75) Inventors: Rolland Russell Martel, Lexington, VA (US); Vicki Jo Hall, Lexington, VA (US); Damon Malkiewicz, Plymouth, MI (US); Stephen Haworth, Orlando, FL (US)

Correspondence Address: ROLLAND R. MARTEL, 110 JOHNSTONE STREET, LEXINGTON, VA, 24450, US

(73) Assignee: Rolland Russell Martel, Lexington, VA (US)

(21) Appl. No.: 11/957,460

(22) Filed: Dec. 16, 2007

(51) Int. Cl. G06Q 40/00; G06Q 30/00

(52) U.S. Cl. 705/14; 705/37; 705/30

(57) ABSTRACT

An Integrated Exchange that consolidates the exchange, broker & clearing house functions into a single platform for continuous 24 hour real time trading of securities, currencies, commodities & other fungibles. Both corporate and individual investors have accounts with the Integrated Exchange. Both corporate and individual investors trade directly with one another electronically through the Integrated Exchange. Account status, statements and cash T+0 settlement, and quotes are all in real time. The exchange's integrated software can perform credit check on new orders and calculate margin of long & short positions and any offsetting positions located in multiple related accounts each of which may have a different account currency. The exchange has 28 order types including visible, prearranged and hidden orders. Integrating the exchange, broker & clearing house functions into a single platform is efficient and leads to reduced execution costs for investors.

### FIELD OF THE INVENTION

This invention relates generally to electronic trading and more particularly to an improved trading system created by consolidating the exchange, broker, clearing house & depository functions into a 24 hour Integrated Exchange for fungibles.

### BACKGROUND OF THE INVENTION

The brokerage industry has automated the trading of listed and NASDAQ securities but has not automated the unlisted market. Corporate participants in the listed market have access to many specialized order entry, order matching systems and program trading tools which are not available to small investors.

The inter-dealer unlisted market continues to do business primarily by telephone as it has done for the last 100 years. At present, investors may have difficulty obtaining bids and offerings for unlisted fungibles that are not regularly quoted. When investors do obtain quotes, they often find the spread between the bid and ask large, which tends to discourage trading in unlisted markets.

The origin of the present invention, an Integrated Exchange, began as a search in the 1990s for a way to automate trading of unlisted securities in Canada. In the process of finding a solution, there appeared to be a number of under serviced niche markets of interest to retail investors in the United States and elsewhere. These niche markets include: municipal bonds, foreign currency, unlisted and foreign securities, Put & Call options and after-hours trading.

The Integrated Exchange is presently operating in real time online 24 hours a day in test mode. At an Integrated Exchange, the retail investor deals directly with the exchange as a member-client. FIG. 1 compares the Integrated Exchange simple structure to the conventional exchange, broker & clearing house operations.

### BACKGROUND OF THE INVENTION continued

Finding an economical solution for after-hours trading led to consolidating certain functions of the exchange, broker & clearing house into an Integrated Exchange that operates 24 hours a day with cash T+0 settlement. The Integrated Exchange concept received a boost from a comment about settlement that Alan Greenspan made to the Financial Markets Conference on Oct. 16, 2000. Mr. Greenspan referred to settlement on T+0 as the ultimate goal.

While the Integrated Exchange incorporates certain broker functions such as client order entry and client accounting, the Integrated Exchange does not compete with traditional broker activities such as underwriting, arbitrage, trading, market making, portfolio management, investment research and financial advice. It is anticipated that brokers will be market makers for many of the securities that trade on the Integrated Exchange.

We believe that 24 hour trading for unlisted securities and foreign currencies is presently unavailable to retail investors in the United States. At this time, none of the exchanges offers 24-hour a day trading. Several exchanges have provisions for the after-close execution of orders at the closing price. Some exchanges have after-hours trading sessions that may last a few hours after the close of an exchange. There are 24-hour order entry systems but we believe that none of these systems presently provide for 24-hour trading.

At present extended after-hours trading is limited to large investors and financial institutions. A recent Wall Street Journal advertisement provides a glimpse of who trades after-hours: Soros Financial Management placed an advertisement for a night execution trader to work the 2 am to 10 am shift. The Integrated Exchange will provide retail investors with access to the after-hours market.

The Summary of the Present Invention which follows describes the four claims made in this application:

(1) Integrated Exchange for fungibles—page 6
(2) Real time 24 hour accounting system—page 7
(3) Credit check of new orders and margin of multiple accounts—page 8
(4) Trader-ID advertisements—page 11

### SUMMARY OF THE PRESENT INVENTION

(1) Integrated Exchange for fungibles with 24 hour trading & continuous cash T+0 Consolidating the exchange, broker & clearing house functions at one location and on one electronic platform, the “Integrated Exchange” is one of two innovations that makes both continuous 24 hour trading and T+0 settlement possible. The Integrated Exchange software was designed specifically for 24 hour trading and T+0 settlement. Also the Integrated Exchange is more efficient because it eliminates duplicate and overlapping functions of the traditional and separate exchange, broker & clearing house interactions. Examples of the efficiency of the Integrated Exchange are:
The Integrated Exchange has only one accounting system instead of three with overlapping information.
As member-clients, both corporate and individual investors can deal directly with one another on the Integrated Exchange.
Open Orders are stored at one location instead of two; see FIG. 2 which illustrates the efficient order entry and order execution process of the Integrated Exchange.
Quotes are delivered directly to the member-clients rather than through third party resellers.
Trade confirmation and affirmation are redundant and therefore are eliminated.
T+0 settlement reduces credit risks.

For the retail investor the efficient common platform for trading and settlement will result in reduced fees. The 24 hour trading allows retail investors who are often busy during conventional exchange business hours to trade at their convenience. These investors have time before or after their workday and on weekends to manage their investments. Operating 24×7 allows investors to enter transactions and receive reports of executed orders at any time on their computer rather than entering an order in the evening for a possible fill the next day which is how order entry presently works when the exchanges are closed.

The Integrated Exchange is a new software application and business method that physically and electronically incorporates certain broker, exchange and clearing house functions into a single platform; it is not merely a broker, exchange and clearing house on the same platform. Technology of Integrated Exchange is discussed on pages 10 to 12.

(2) Real time 24 hour accounting system: A real time continuous 24 hour accounting system is the second of two innovations that make both continuous 24 hour trading and T+0 settlement possible. In contrast, most if not all exchanges, brokers and banks still use batch accounting systems that preclude operating an efficient 24 hour exchange.

The Integrated Exchange has an accounting system that tracks both money and fungibles. The accounting system has an open ledger without sub ledgers. The accounting system presently offers two account currencies, US$ and Cdn$ and will offer more currencies to accommodate both foreign investors and domestic investors of foreign fungibles.

The Integrated Exchange is the non-obvious union of consolidating the exchange, broker & clearing house functions into one platform with an accounting system that operates 24 hours a day. While the present invention is simple, it is not obvious even to practitioners in the financial industry. Execution of the invention is not simple, especially the development of Credit-check which consumed most of the development work.

(3) Credit-check of new orders & margin of multiple accounts: Credit-check operates 24 hours a day seven days a week and is key part of the Integrated Exchange software. Credit-check's importance in the process flow is illustrated in FIG. 2. The Integrated Exchange has an elaborate Credit-check specifically to facilitate the unlisted Put & Call option market.

In broker vernacular, Credit-check margins one or multiple related accounts to determine whether there is adequate security in the account to support any loan that the exchange makes to a member. At the Integrated Exchange, Credit-check is defined as:

“Credit-check is a process:
(1) to determine whether a member has sufficient assets and/or credit in the member's account(s) to enter a new order;
(2) to determine if there are sufficient assets in a member's account(s) to support any loan that the exchange has made to the member.”

As a concept, Credit-check compares the value of a new order to the value of the account to determine if a new order should proceed to a Trading-market. Also Credit-check evaluates accounts to ensure that their assets have sufficient value to secure any liabilities that the accounts may have. In practice the process is complicated by short-sales, warrants, call-options, related accounts, guaranteed accounts, multiple accounting currencies and credit procedures.

The invention claimed with Credit-check is the ability of Credit-check to margin assets & liabilities, including long and short positions, located in more than one related account as if the assets were located in one account. In addition, the ability to identify and margin indirect offsetting positions, such as Short common shares offset by Long Calls, in different related accounts which may have different account currency is also part of the invention claimed with Credit-check. FIG. 3 shows the account-status windows of two related accounts that are margined together.

We believe that with Credit-check, the Integrated Exchange is the only exchange for retail investors that can margin offsetting security positions located in multiple accounts. We believe that with Credit-check, the Integrated Exchange is the only trading system or exchange that can margin offsetting security positions located in multiple accounts 24 hours a day. Paragraphs [0022] to [0025] describe one embodiment of how Credit-check works.

How Credit-check works: At the Integrated Exchange, each security is assigned attributes in addition to the traditional name, CUSIP number & symbol that may form part of the security description. At the Integrated Exchange, these attributes include such things as: shortname, loan-rate, short-sale-status, strikeprice etc. The attributes of two securities margined in FIG. 3 are shown here to help explain the Credit-check process.

The attributes required to margin Cybertel common shares are:

Shortname—CYBERTEL

Class—common

Short-sale-status—YES

Loan-rate—50 percent

The attributes required to margin Cybertel Calls to buy Cybertel common at $8 until Oct. 25, 2007 are:

Shortname—CYBERTEL-Call$8-Oct25-07

Class—Call

Short-sale-status—YES

Loan-rate—zero percent

Strikeprice—$8.00

Optioned-security—CYBERTEL

Option-Exercise-ratio—1

ExpiryDate—25 Oct. 2007

The method to margin the two Testmember33 accounts involves several steps:

(1) In a temporary file, arrange the money balances and securities (Shorts above longs) of the two Testmember33 accounts into a single account format;
(2) Refresh the values of all securities in the combined related accounts;
(3) Revise market values of all securities;
(4) Revise total value of securities and total value of accounts;
(5) Revise loan-value of each long position;
(5a) Calculate over-concentration if applicable.
   (6) Revise loan-value of Short positions by putting the Short positions only including open sell orders into a second temporary files;
(6a) For the Short 2,000 CYBERTEL, a search of the Shortname attribute of the six long positions for CYBERTEL is made; nothing is found;
(6b) A second search is made in the Underlying-security attribute of the six long positions for CYBERTEL; nothing is found (note—the Underlying security feature is the security into which for example a convertible preferred or convertible bond is convertible);
(6c) A third search is made in the Optioned-security attribute of the six long positions for CYBERTEL; and 10,000 CYBERTEL-Calls are found. The quantities are compared and the loan value of the 2,000 CYBERTEL Short is 16,000 which is the strike price of 2,000 CYBERTEL-Calls. The 2,000 CYBERTEL-Calls are removed from the list of Long positions and placed beside the 2,000 CYBERTEL Short position.
   (7) The loan-values of the other Short positions in the second temporary file, including open sell orders, are revised in a similar manner. The final position of the second temporary file used to revise the loan-values of the Short positions is called the Offset-view. The Offset-view, available to the exchange staff only, is a picture of the automated margin process and is not part of the account display for the member-clients. Pictures of the Offset-view are used for quality control. See FIG. 4 for the Offset-view of the two combined Testmember33 accounts.
   (8) The second temporary file is closed.
   (9) The sum of the loan-value of securities is calculated.
   (10) Group loan-value is calculated.
   (11) Group open order credit is calculated.
   (12) Margin of the two accounts is completed; the last step is to display the information from the temporary file into the two related Testmember33 accounts shown in FIG. 3.

(4) Trader-ID advertisement: Each member-client user of the Integrated Exchange may have a 80 character advertisement attached to each of their open orders for display in any trading market that the member-client has an order. Trader-ID allows individual investors to contact one another to arrange trades or discuss the size of an order. Trader-ID advertisements are free. Typical Trader-ID advertisements are:

damon@e3trader.com

540-464-5333 CALLS BOT & SOLD

905 276 7858 FOREIGN CURRENCY

Brokers may use Trader-ID to advertise their specialized service. See FIG. 5 for examples of Trader-ID in the Danish Krone and e-Exchange trading markets.

If a user wishes to remain anonymous, the exchange assigns a Trader-ID such as Z117, K225 or N777. Also a user can choose an alias such as GOLDBUG or MUNCIE to remain anonymous.

Contacting other investors or brokers is essential to negotiate the terms of a prearranged cross prior to order entry and order execution. A prearranged cross consists of a Buy-prearranged and Sell-prearranged order each of which contains a negotiated ordercode to ensure the two orders are matched. Prearranged orders are part of 28 different order types that the Integrated Exchange offers to its users.

Trader-ID is an efficient way for investors to contact one another during the after-hours trading of listed securities. Trader-ID is essential for arranging trades of thinly traded fungibles such as
Put & Call options
unlisted securities
minor foreign currencies
foreign currency derivatives
Delayed Delivery securities (single stock futures)
listed securities
strip bonds & coupons
gold & silver coins & bullion
commodities
other fungibles & derivatives

### BRIEF DESCRIPTION OF DRAWINGS

FIG. 1—Integrated Exchange Simple Structure

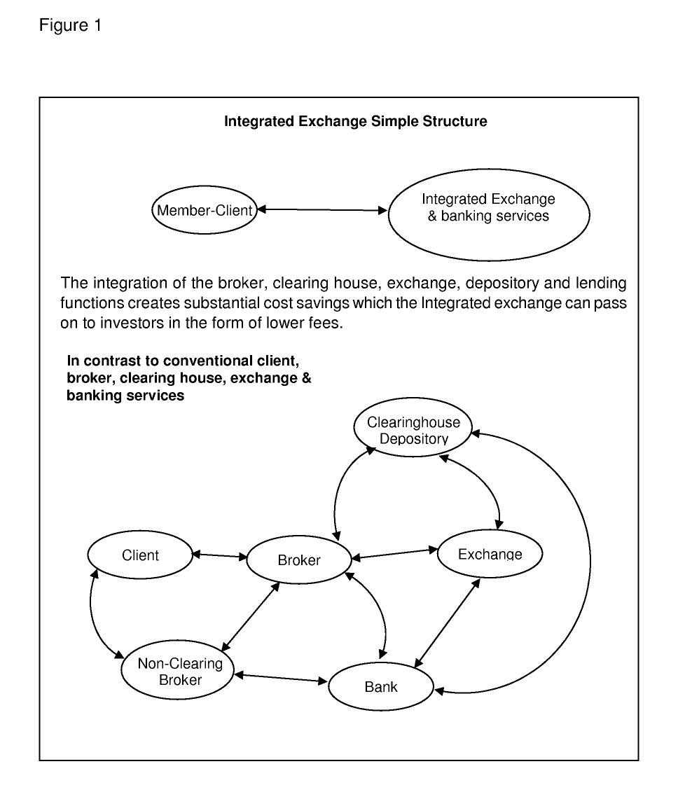

FIG. 2—Integrated Exchange 24-hour real time order entry & execution overview

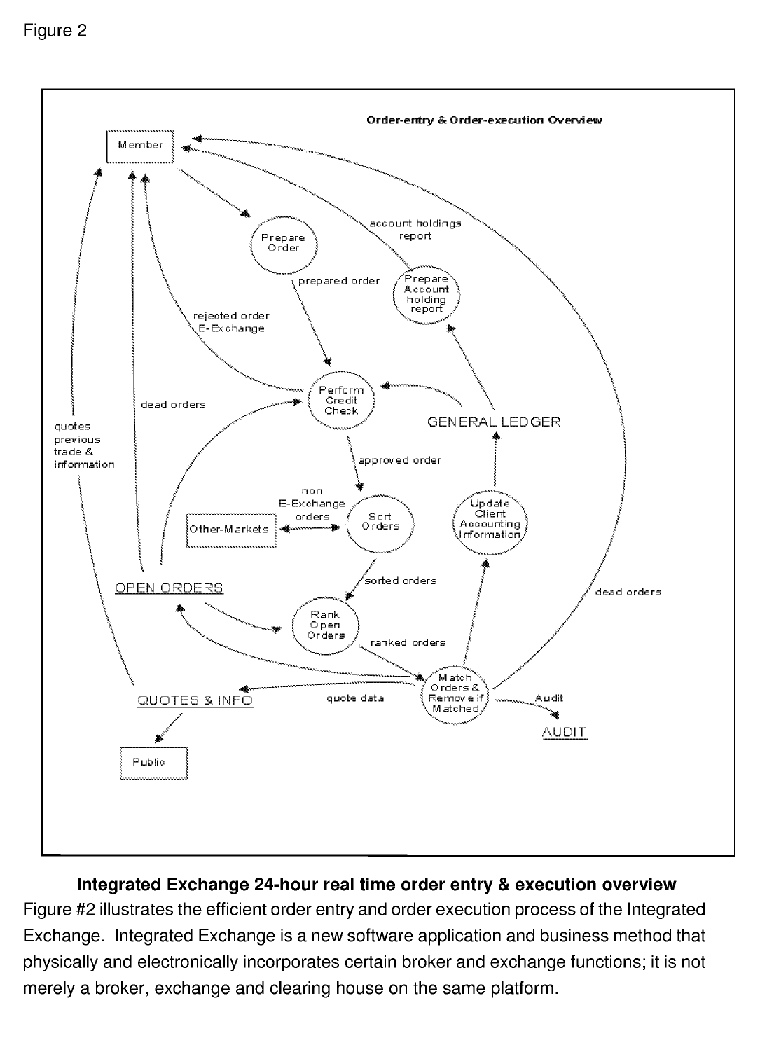

FIG. 3—Testmember33 related US$ & C$ accounts

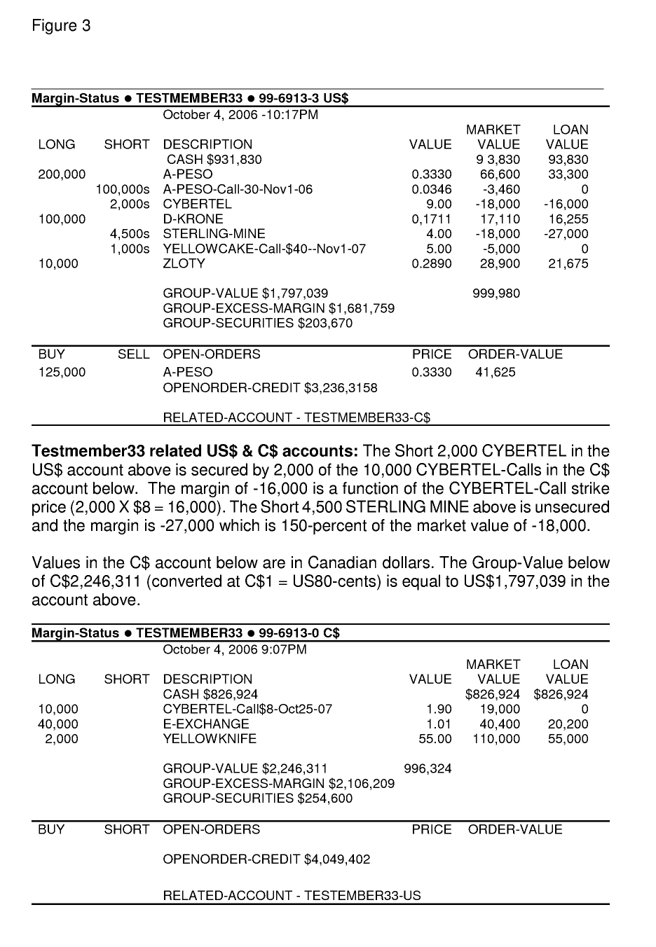

FIG. 4—Offset-view report

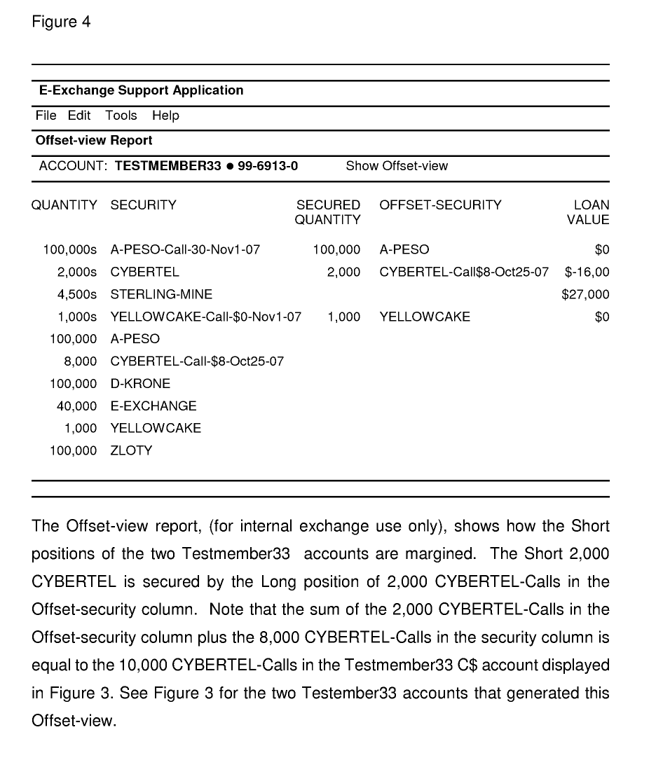

FIG. 5—Trading-markets showing Trader-ID

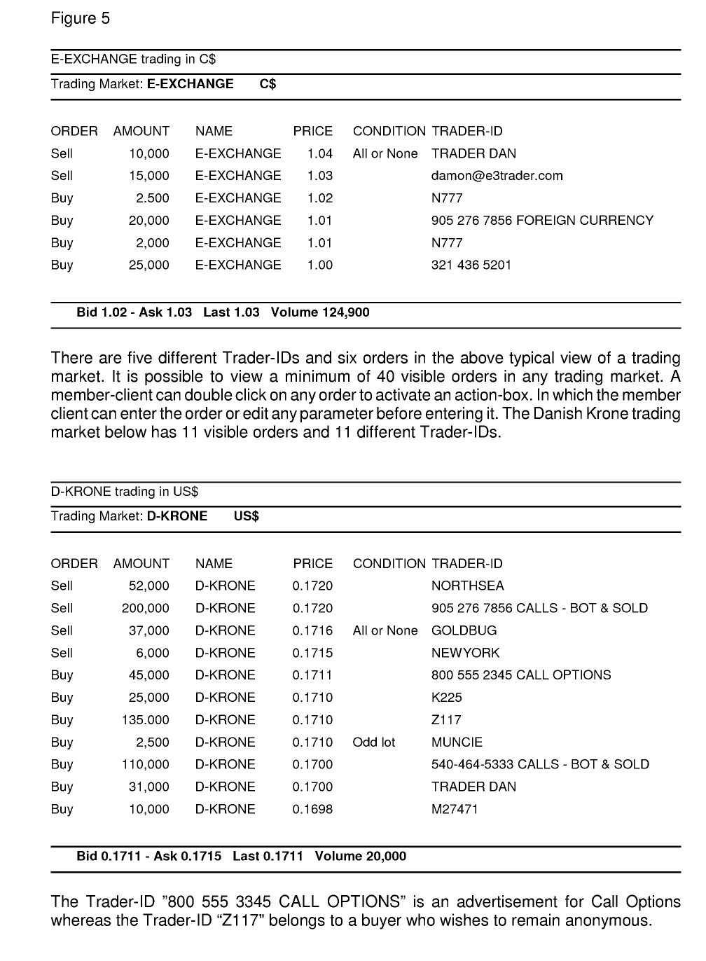

FIG. 6—High level logical architecture and process flow

The Integrated Exchange is designed as a real-time system that is highly reliable, secure and scalable. It is structured in a manner that allows for
rapid development and deployment of new software features in response to changing information needs and business requirements;
effective data security among system users and system security protection against external threats; and
efficient processing of online transaction data.

System Reliability: The Integrated Exchange is designed for high availability through a number of redundancy techniques implemented at the hardware, software, and geographic levels. Clustering, RAID, and network redundancy technologies help to ensure maximum uptime of the Integrated Exchange's servers. Component services that support scaling have been designed to maximize the software's multi-tiered architecture.

System Security: System security is accomplished at many different levels.
Level 1: This is the DMZ for the corporate network. It incorporates several outward facing routers and firewalls, and basically locks down traffic to only a few protocols including HTTP, HTTPS, FTS & SMTP.
Level 2: This is the web services level, and is comprised of load balancing equipment, web servers and inline intrusion detection filters.
Level 3: The database servers exist on this level. The division between levels 2 and 3 is a second firewall layer that allows ODBC traffic only, and only to the front end web servers (filtered by MAC address).

The network for the corporate systems is completely separate from the trading system, and is protected in much the same way. There are secured bridges into the different servers for administrative work.

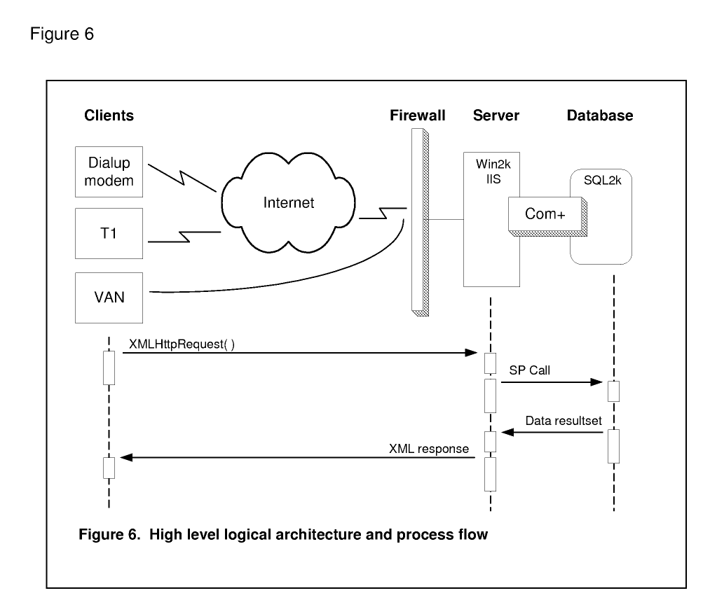

Application Architecture: The Integrated Exchange system is designed modeling a three-tier architecture, where user, business, and data services are segregated to help improve scalability and maintainability. The system has been developed using Microsoft technology. A technical overview of the Integrated Exchange is shown in FIG. 6.

User/Presentation tier—Visual Basic is used to develop a content-rich and flexible Member-software application. It utilizes XMLHttpRequests for transferring disconnected recordsets from the server while polling for updates. It communicates securely with the business tier in Extended Markup Language (XML), which allows for future adaptability into non-Win32 clients.

Business tier—This serves as a ‘middle-man’ between the user services and data services. Internet Information Server (IIS) is utilized at this layer to reap the many benefits offered by web technology. This solution also eliminates the data transfer ‘choke point’ by leaving the data on the web server, therefore simplifying the security challenges and issues of remote access over a firewall. Future performance demands can easily be met by adding additional hardware. Communications between business and data tiers use Com+ components developed in Visual Basic.

Data tier—This layer exhibits both a logical and physical separation of data from other tiers. Stored Procedures at this layer query a SQL Server 2000 database and return data result sets to Com+ components. Future performance demands can also be easily met at this layer by adding additional hardware.

Communications: e-Exchange operates by maintaining continuous communications between the clients and servers. A polling loop will iterate at an interval dependant upon connection type, submitting requests to the servers and wielding responses. Requests are submitted in streamlined HTTP over a TCP/IP connection and responses are returned in XML. This request-response design is modeled after world wide web framework.

Technology Requirements for Members/Clients: The Member software is written with compatibility in mind, supporting all Microsoft operating systems from Windows 98 through Windows 2003. An internet, LAN, or VAN connection is required for accessing the system.

Who to Call:

For information about Integrated Exchange technology, call Damon Malkiewicz at 734 834 7683 or dmalk@comcast.net.
For other information about Integrated Exchange, call Russell Martel at 540-464-5333, cellular 506-470-5049 or rollandmartel@gmail.com; 110 Johnstone Street, Lexington Va. 24450

The invention claimed is:

1. An Integrated Exchange, an apparatus and process that consolidates the exchange, broker, clearing house and depository functions into a single platform for continuous 24 hour real time trading of fungibles and cash T+0 settlement.

2. A process for a continuous 24 hour real time accounting system that updates and displays each account as each entry, receipt, delivery or transaction is made in any of the accounts of the Integrated Exchange described in claim 1.

3. A process to perform real time 24 hour credit check for new orders, and calculate and display margin of long & short positions and any offsetting positions located within any account with the same or different account currency as any other account of a group of related accounts on the Integrated Exchange described in claim 1.

4. A process for investors to advertise to other investors by attaching Trader-ID advertisement to their buy and/or sell orders for viewing by other users of the Integrated Exchange described in claim 1.
